(19) United States
(12) Patent Application Publication
(10) Pub. No.: US 2015/0170013 A1
(43) Pub. Date: Jun. 18, 2015

(54) Fabricating Information Inside Physical Objects for Imaging in the Terahertz Region

(71) Applicant: Microsoft Corporation, Redmond, WA (US)

(72) Inventors: Andrew D. Wilson, Seattle, WA (US); Karl D.D. Willis, San Francisco, CA (US)

(73) Assignee: Microsoft Corporation, Redmond, WA (US)

(21) Appl. No.: 14/106,728

(22) Filed: Dec. 14, 2013

(51) Int. Cl. G06K 19/06; G05B 15/02; B29C 67/00; G01J 3/28; G06K 7/12

(52) U.S. Cl. CPC G06K 19/06037; G01J 3/28; G06K 7/12; B29C 67/0088; G05B 15/02; B33Y 50/02

(57) ABSTRACT

The infrastruct fabrication and imaging technique described herein uses digital fabrication techniques to embed information inside objects and THz imaging to later decode this information. Information is encoded in a digital model to create structured transitions between materials. Digital fabrication is used to precisely manufacture the digital model with material transitions enclosed internally. A THz Time-Domain Spectroscopy (TDS) system is used to create a volumetric image of the object interior. The volumetric image is processed to decode the embedded structures into meaningful information.

### BACKGROUND

Computer-controlled digital fabrication technologies are rapidly changing how objects are manufactured. Both additive (e.g., 3D printing) and subtractive (e.g., laser cutting) techniques use digital information to programmatically control the fabrication process. Unlike conventional manufacturing, one individual object can differ significantly from the next. The ability to manufacture one-off objects has implications not only for product customization and on-demand manufacturing, but also for tagging objects with individualized information.

Object tagging systems have wide-ranging uses in logistics, point of sale, robot guidance, augmented reality, and many other emerging applications that link physical objects with computing systems.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In general, the infrastruct fabrication and imaging technique described herein embeds a volumetric tag in a three dimensional (3D) physical object. In one embodiment the technique creates a novel volumetric tag design, sometimes called an infrastruct herein, which embeds information in the interior of a digitally fabricated object and is read using a Terahertz (THz) imaging system. Infrastructs, literally meaning ‘below structures’, are material structures that may not be visible to the eye but can be clearly imaged in the THz region. By modulating between materials, information can be encoded into the volumetric space inside objects.

In some embodiments, the technique pairs modulated material structures inside digitally fabricated objects with THz imaging to sense material transitions. The technique enables arbitrary information to be encoded and decoded from entirely within physical objects. The technique can construct machine-readable tags inside physical objects using digital fabrication. It also provides for techniques for sensing, interpreting, and processing THz imaging data to extract tag information. Tag designs include Gray codes for location encoding, geometric structures for pose estimation, random voids for object identification, matrices for data storage, and visual data for object authentication. However, these tag designs, and other tags designs, can be used for a variety of other applications and purposes.

### DESCRIPTION OF THE DRAWINGS

The specific features, aspects, and advantages of the disclosure will become better understood with regard to the following description, appended claims, and accompanying drawings where:

FIG. 1 depicts an exemplary Terahertz (THz) system emitting a pulse of THz radiation and measuring reflections from material interfaces measured at the outer and inner surfaces of an object.

FIG. 2 depicts a flow diagram of an exemplary process for practicing one embodiment of the infrastruct fabrication and imaging technique described herein.

FIG. 3 depicts a flow diagram of another exemplary process for practicing another embodiment of the infrastruct fabrication and imaging technique described herein.

FIG. 4 depicts a system for implementing one exemplary embodiment of the infrastruct fabrication and imaging technique described herein.

FIG. 5 shows a schematic of how infrastruct tags are created by encoding information into a digital model that is then fabricated with material transitions inside a physical object. The object's internal volume is imaged in the THz region and decoded into meaningful information.

FIG. 6 depicts the internal material structure of a simple infrastruct tag. A reflected THz Time Domain Spectroscopy (TDS) signal shows peaks at the interfaces between materials that are decoded into binary form.

FIG. 7A depicts a Gray code tag design according to one embodiment of the infrastruct fabrication and imaging technique.

FIG. 7B depicts a geometric tag design according to one embodiment of the infrastruct fabrication and imaging technique.

FIG. 7C depicts a random void tag design according to one embodiment of the infrastruct fabrication and imaging technique.

FIG. 7D depicts a matrix tag design according to one embodiment of the infrastruct fabrication and imaging technique.

FIG. 7E depicts a visual tag design according to one embodiment of the infrastruct fabrication and imaging technique.

FIG. 8 depicts ray scan, planar scan and volume scan configurations used to scan the infrastruct tags described herein using a THz imaging system.

FIG. 9 is a schematic of an exemplary computing environment which can be used to practice the infrastruct fabrication and imaging technique.

### DETAILED DESCRIPTION

In the following description of the infrastruct fabrication and imaging technique, reference is made to the accompanying drawings, which form a part thereof, and which show by way of illustration examples by which the infrastruct fabrication and imaging technique described herein may be practiced. It is to be understood that other embodiments may be utilized and structural changes may be made without departing from the scope of the claimed subject matter.

### 1.0 Infrastruct Fabrication and Imaging Technique

The following sections provide an introduction to the infrastruct fabrication and imaging technique, as well as exemplary embodiments of processes and an architecture for practicing the infrastruct fabrication and imaging technique. Details of various embodiments and components of the infrastruct fabrication and imaging technique are also provided.

As a preliminary matter, some of the figures that follow describe concepts in the context of one or more structural components, variously referred to as functionality, modules, features, elements, etc. The various components shown in the figures can be implemented in any manner. In one case, the illustrated separation of various components in the figures into distinct units may reflect the use of corresponding distinct components in an actual implementation. Alternatively, or in addition, any single component illustrated in the figures may be implemented by plural actual components. Alternatively, or in addition, the depiction of any two or more separate components in the figures may reflect different functions performed by a single actual component.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner.

### 1.1 Introduction

Computer-controlled digital fabrication technologies are rapidly changing how objects are manufactured. Both additive (e.g., 3D printing) and subtractive (e.g., laser cutting) techniques use digital information to programmatically control the fabrication process. Unlike conventional manufacturing, one individual object can differ significantly from the next. The ability to manufacture one-off objects has implications not only for product customization and on-demand manufacturing, but also for tagging objects with individualized information.

Object tagging systems have wide-ranging uses in logistics, point of sale, robot guidance, augmented reality, and many other applications that link physical objects with computing systems. 1D and 2D barcodes have been successful due to their low cost, but are limited by their obtrusive appearance that is visible to the human eye. Radio Frequency Identification (RFID) tags can be embedded inside objects but typically require electronic components beyond the capabilities of current digital fabrication technologies.

The infrastruct fabrication and imaging technique described herein provides a novel volumetric tag design, herein called an infrastruct. Infrastructs are material based tags that embed information inside physical objects for imaging in the Terahertz (THz) region. Infrastructs, literally meaning ‘below structures’, are material structures that may not be visible to the eye but can be clearly imaged in the THz region. By modulating between materials information can be encoded into the volumetric space inside of objects.

Terahertz imaging can safely penetrate many common materials, opening up new possibilities for encoding hidden information inside digitally fabricated objects. Infrastruct tags are embedded during the manufacturing process to immediately identify objects without any additional labeling or packaging. Inexpensive polymer materials can be used to create a layered internal structured. The object interior is scanned to create a volumetric image that is decoded into meaningful information.

As digital fabrication enables a wide range of physical forms to be created, an equally wide range of applications for infrastruct tags are possible. Tag designs that support identification of digitally fabricated objects have applicability in production line inventory and point of sale systems. For example, the ability to accurately identify individual 3D printed objects within a large batch can increase the efficiency of production logistics. As infrastruct tags do not require additional stickers or labeling for machine-readability they can be used for ecologically-friendly packaging. Customized objects created with personal 3D printers can be identified and connected to the Internet of things' as soon as they are fabricated using infrastructs. Robotics applications can utilize THz planar scan systems to not only reveal depth information, but also identify and track objects in the environment. With future improvements in THz scanning technology many human-computer interaction applications may be realized. Gray code patterns can be embedded in customized game accessories to sense location with a single THz ray, scan when within range. Volume scan configurations can image behind game accessories using the latter part of the THz signal. The see-through ability of THz can also extend tabletop computing scenarios where objects are stacked, buried, or inserted inside other objects, and would typically be occluded from conventional cameras.

THz waves have low photon energies that do not cause harmful photoionization in biological tissues and are generally considered to be safe for humans. Current THz systems typically have a maximum emission power of a few μW.

In the following sections, background information, exemplary processes and an architecture for practicing the technique are described. Additionally, details of various components and embodiments of the technique are described.

### 1.2 Background

The need to tag objects with machine-readable information is a well established requirement of ubiquitous computing and has given rise to a number of solutions in both the radio frequency (RF) and optical domains. THz radiation benefits from its unique location between the RF and optical wavelengths on the electromagnetic (EM) spectrum. In this section THz imaging is compared to other approaches in the surrounding areas of the EM spectrum and work related to tag fabrication is discussed.

1.2.1 Comparison with RF Approaches:

Tag systems utilizing RF have the ability to penetrate a range of materials, but provide limited spatial resolution for imaging due to their longer wavelengths. Although ultrawideband radar has been used for seethrough-wall imaging, forming an accurate image from reflected radar waves is the subject of ongoing research. Radio Frequency Identification (RFID) tags typically consist of an antenna and integrated circuit powered by an active reader. RFID approaches can provide some localization data based on radio signal strength information, but are imprecise due to a lack of directionality. RFID tags have been coupled with optical sensing to improve spatial localization. Unlike RF approaches, THz frequencies enable high resolution volumetric imagery to be accurately sensed from precise locations inside an object. Information can be encoded in either machine-readable digital or human-readable visual form.

1.2.2 Comparison with Optical Approaches:

Optical imaging with visible and near-IR light provides high spatial resolution but cannot penetrate visibly opaque materials. Both 1D and 2D barcodes rely on line of sight to be detected and are sensitive to changing lighting conditions. Barcode tags are typically visible to the human eye and have an obtrusive geometric appearance. Time of flight (TOF) depth cameras could potentially be used to read encoded depth information on the first, or even second, surface of objects they encounter. However, information about internal surfaces cannot be detected using visible/IR emission sources. When compared with other optical approaches, THz imaging is unique in its ability to see inside objects and sense material transitions. THz imaging is related to ‘millimeter wave’ technologies used in full-body scanners commonly found in airports. However, due to shorter wavelengths, higher resolution images can be achieved in a much more compact form-factor.

1.2.3 Tag Fabrication:

New tools and uses for digital fabrication are rapidly being explored. Techniques for embedding spatial information in digitally fabricated objects have to date focused on surface geometry. There does not appear to be any prior work that allows machine readable tags to be embedded inside of a digitally fabricated object. Although most RFID tags use integrated circuits, chip-less printable tags have been demonstrated with inkjet-printable transistors and passive spiral resonators. Although promising, integration of printed electronics with digital fabrication is still in the early research stages. Initial work using chip-less RFID tags in the THz frequencies has been explored with dielectric materials in a Bragg structure. The infrastruct fabrication and imaging technique encodes information in the time domain, rather than the frequency domain used by RFID. A number of unique materials have been used to conceal optical barcode tags from the human eye. These include transparent retroreflective films, lenslets arrays, and IR-absorbing inks. The use of specialized materials, however, greatly limits the ease of fabrication. By using common polymer materials, infrastruct tags can be fabricated on a range of standard equipment.

### 1.3 THz Imaging

The following paragraphs provide an overview of THz imaging. The properties of THz radiation and time-domain spectroscopy are briefly introduced below.

1.3.1 THz Radiation

The THz band of the electromagnetic (EM) spectrum lies between microwaves and infrared (IR) light. This so-called ‘THz gap’ is typically classified between 0.1-10 THz (λ=3000-30 μm). A relative lack of convenient and inexpensive THz emitters and detectors left the THz band relatively unexplored up until the 1970s. THz radiation can penetrate many common plastics, papers, and textiles. THz radiation is a non-ionizing, safer alternative to X-rays with power emission on the μW level.

1.3.2 THz Imaging

The properties of THz radiation and time-domain spectroscopy are now briefly introduced.

1.3.3 Time-Domain Spectroscopy

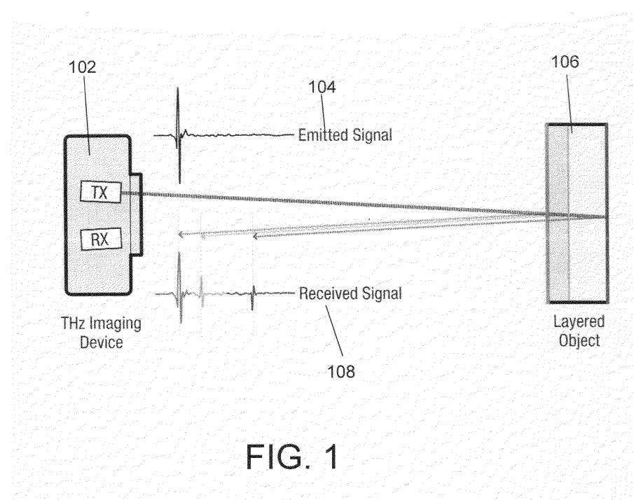

The most common approach to THz imaging has to date been Time-Domain Spectroscopy (TDS). Similar to time-of-flight (TOF) depth cameras, TDS systems perform active illumination and measure the signal reflected back from the scene. Rather than measuring only the flight time of the signal, a TDS system 102 emits a broadband pulse of THz radiation 104 directed at an object 106 and measure the entire reflected signal 108 as a waveform (as shown in FIG. 1). Each ‘pixel’ in a TDS image consists of a time-domain signal with peaks that indicate reflected energy from both the outer and inner surfaces of objects in the scene. The entire image forms a volumetric dataset that can be used to slice through an object along the depth axis and reveal the 3D structure. Until recently THz imaging devices were not capable of interactive scan rates, leaving a vast array of possibilities unexplored. Volumetric data acquisition for TDS systems is still relatively slow, but real-time line-scan systems are commercially available and tomographic imaging can also be used. Although other forms of THz systems do exist, e.g., continuous-wave systems, the technique described herein uses TDS systems due to the richer dataset generated.

An introduction to the infrastruct fabrication and image technique, background information and information on THz imaging having been provided, the following section provides a description of some exemplary processes for practicing the technique.

### 1.4 Exemplary Processes for Practicing the Technique

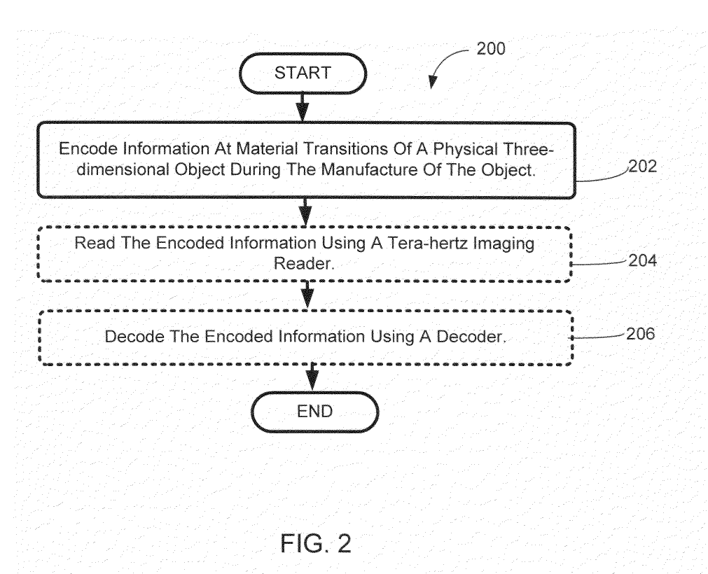

FIG. 2 depicts an exemplary process 200 for practicing one embodiment of the technique. The computer-implemented process 200 creates a volumetric machine-readable tag that is embedded in a three dimensional physical object. As shown in block 202, this is done by encoding information at material transitions of layers of the physical object during manufacture of the object in order to create the volumetric machine-readable tag that is readable in the Terahertz frequency range.

Layers of materials of different refractive properties are used to create the volumetric machine-readable tag. For example, in one embodiment of the technique a multi-layered spatial gray code pattern is used to encode the information in the volumetric machine-readable tag. A ray scan configuration can be used to read the information on this volumetric machine-readable tag. Alternately, the volumetric tag can be embedded in an object in a manner so as to provide information on how the object is positioned and oriented. Or tag information can be randomly placed under the surface of the object as a unique footprint of the object that can be scanned and matched to a 3D model containing the position of all of the features of the object. Still another tag configuration comprises a volumetric tag that is a matrix tag that contains layers of digital information encoded as physical bits and that is imaged using a volume scan configuration. Some volumetric tags have a three dimensional shape that is recognizable by a human when scanned. These types of tag designs are discussed in greater detail in Section 1.6.4 of this Specification.

All of the tags listed above can then be optionally read by a terahertz (THz) imaging reader, as shown in block 204, and, as shown in block 204 the information can be decoded by a decoding algorithm such as the one discussed in Section 1.6.3, for example.

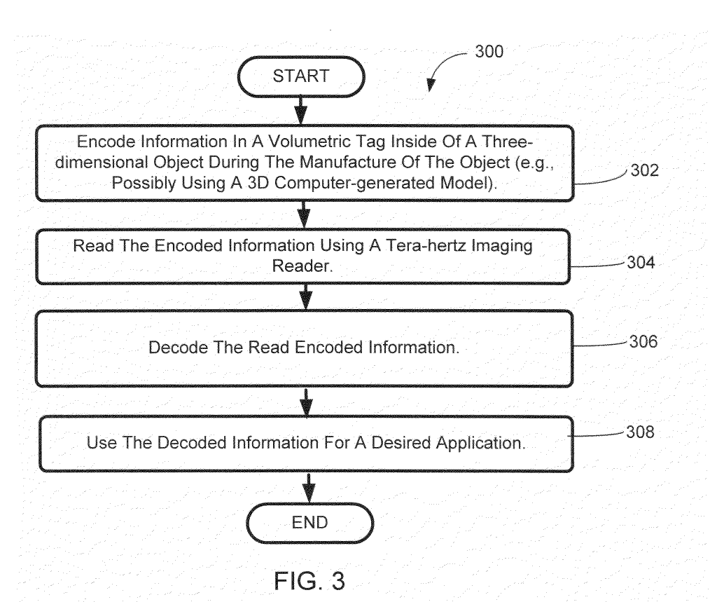

FIG. 3 depicts another exemplary process 300 for practicing the technique. This process is a computer-implemented process for embedding information in a volumetric tag inside of a 3D physical object by encoding information inside a volumetric tag inside the object during manufacture of the object, as shown in block 302.

In one embodiment the physical object is digitally fabricated, such as, for example, by using a three-dimensional printer or a laser cutter. These additive or subtractive tag fabrication techniques are described in greater detail later in Sections 1.7.1 and 1.7.2 of this Specification. Like the embodiment discussed above with respect to FIG. 2, the information is encoded at material transitions of layers of the physical object in order to create the volumetric machine-machine readable tag and there are many tag designs possible.

The encoded information is then read using a THz imaging reader, as shown in block 304. For example, the encoded information is read by emitting a pulse of THz radiation toward the object and measuring the reflected pulse from material interfaces encountered at outer and inner surfaces of the object. In one embodiment of the technique this emitted pulse is typically a broadband pulse and the entire measured reflected pulse is measured as a waveform. The THz imaging reader uses TDS images of the surface and the interior of the physical object to read the encoded information. In one embodiment of the technique, each pixel of a TDS image comprises a time-domain signal with peaks that indicate reflected energy from both the outer surfaces and the inner surfaces of the physical object. The entire TDS image forms a volumetric data set that can be used to slice through the object along the depth axis of the object and reveal the three dimensional structure which can be read and interpreted. The read encoded can then be decoded (as shown in block 306). Detailed information on one possible decoding process is discussed in Section 1.6.3.

The volumetric tag can be used for various purposes (as shown in block 308), such as, for example, authenticating an object as coming from a specific source or identifying an object by serial number or other identifier. Additionally, the volumetric tag can also be used for data storage. Other applications include inventory management, robot guidance, augmented reality and the like.

Exemplary processes for practicing the technique having been provided, the following section discussed an exemplary architecture for practicing the technique.

### 1.5 an Exemplary Architecture for Creating and Using an Infrastruct Tag According to the Technique

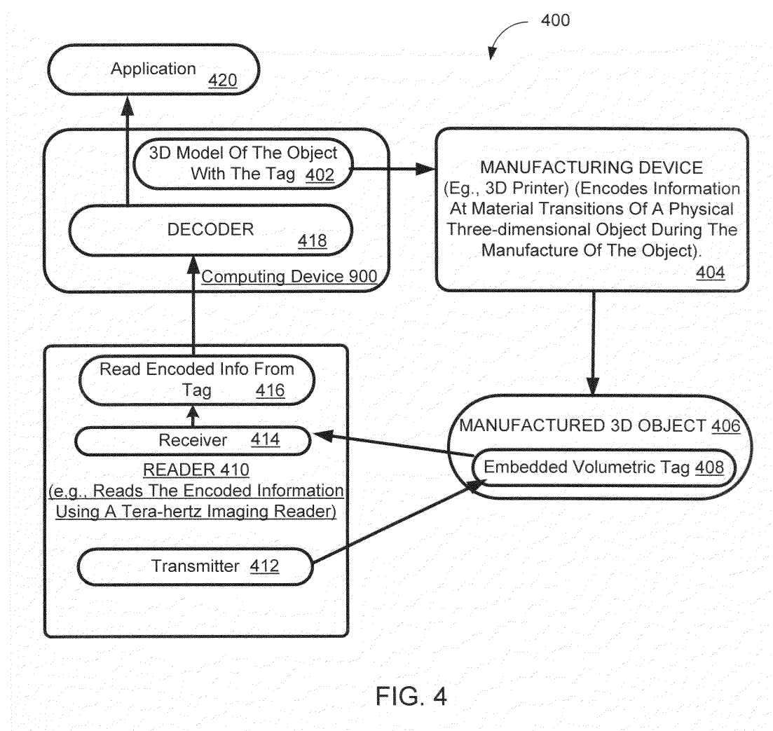

FIG. 4 provides an exemplary architecture for practicing one embodiment of the technique described herein. FIG. 4 depicts a system 400 for encoding a machine-readable tag inside of an object during manufacture of the object and reading and decoding that tag.

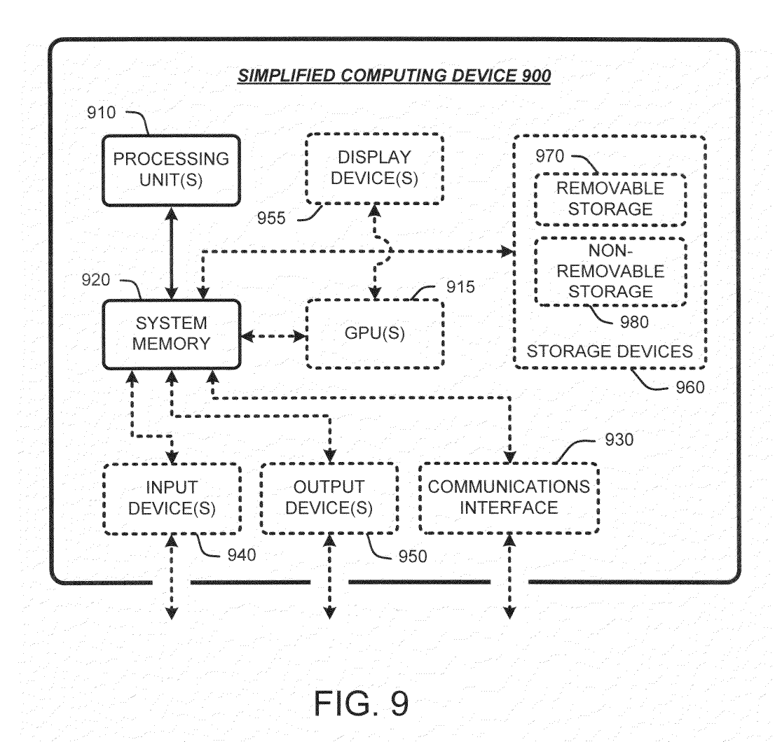

A three-dimensional model 402 of the object with the tag 306 inside is created. This can be done, for example, by using a modeling application on a computing device, such as a computing device 900 that is described in greater detail with respect to FIG. 9. The 3D model with the tag with the embedded information in it is then provided to a manufacturing device 404, such as for example, a 3D printer.

Information is encoded inside the volumetric tag 408 inside the three-dimensional physical object 406 during manufacture of the object. This is done by encoding information at material transitions of layers of the physical object during manufacture of the object in order to create the volumetric machine-readable tag that is readable in the THz frequency range. Layers of materials of different refractive properties are used to create the volumetric machine-readable tag. Details of the tag fabrication process are provided in greater detail in Sections 1.6 and 1.7.

The encoded information in the volumetric tag 408 can then be read by using a THz imaging reader 410 that has a transmitter 412 that emits a pulse in the THz frequency range and a receiver 414 measures the reflections from material interfaces encountered on the outer and inner surfaces of the object. The read encoded information 416 can be decoded by a decoder 418 by converting the read coded information into the time domain and decoding the tag structure using the product of the distance pulse has traveled and the refractive index of the medium it traveled through. As discussed previously, an exemplary decoding process is described in greater detail in Section 1.6.3. The decoded information can then be used for one or more applications as previously discussed.

### 1.6 Details and Exemplary Computations for Fabrication and Use of Infrastruct Tads

This section provides details for various methods of and computations for fabricating and imaging the infrastruct tags created according to various embodiments of the technique.

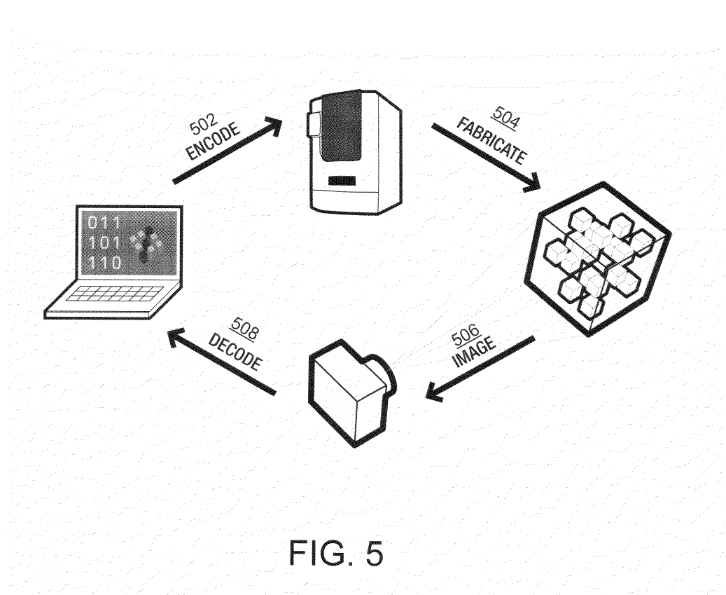

As discussed previously, the technique uses digital fabrication techniques to embed information inside objects and THz imaging to later decode this information. FIG. 5 shows a conceptual overview of how infrastructs are encoded, fabricated, imaged, and decoded. (a) As shown in 502, information is encoded in a digital model to create structured transitions between materials. (b) Digital fabrication is used to precisely manufacture the digital model with material transitions enclosed internally, as shown in 504. (c) A THz TDS system is used to create a volumetric image of the object interior, as shown in 506. (d) As shown in FIG. 508, the volumetric image is processed to decode the embedded structures into meaningful information.

1.6.1 Overview

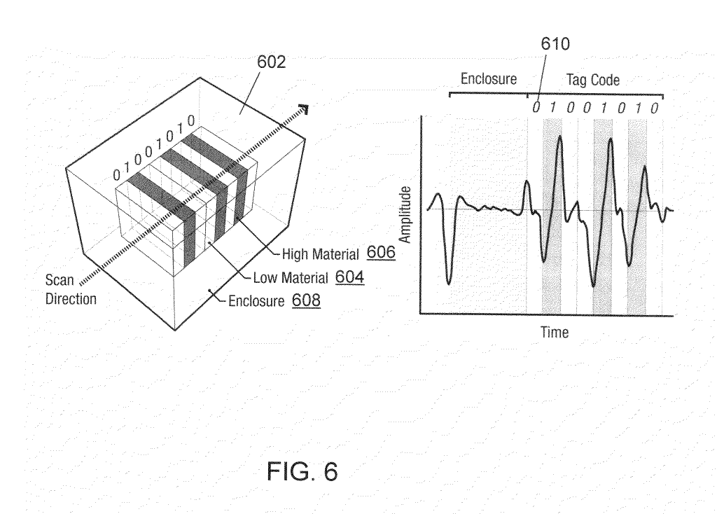

Infrastructs can be used to encode information in numerous ways. Before individual tag designs are introduced, an illustrative example of a simple 1D tag used to encode eight bits of binary information is provided FIG. 6, 602. This tag 602 consists of two modulated materials 604, 606 surrounded by an outer enclosure 608. The ‘high material’ 606 has a higher refractive index and represents a high (1) binary state. The low material′ 604 has a lower refractive index and represents the internal code, reflecting a signal at each material interface. FIG. 6, 610, illustrates the returned signal from a single scan through the structure. The scan first passes through the enclosure material, reflecting a negative peak as it enters a material with a higher refractive index, then a positive peak as it transitions to a material with a lower refractive index. Similar positive-negative peak pairs occur as the scan passes through each layer of high material embedded within the tag itself. The full signal is decoded into binary form by comparing the timing of peaks to the known tag structure and material refractive index. Using this procedure, binary information can be encoded simply by varying the material structures within a physical object. Now the technical factors that govern the fabrication, imaging, and design of infrastruct tags according to some embodiments of the technique will be discussed.

1.6.2 Material Model

Material selection is a key consideration that determines the strength of reflected signals and the degree of material penetration. Material performance for a tag based can be modeled based on two factors: reflected radiation—the amount of radiation reflected at the interface between two materials, and transmitted radiation—the amount of radiation transmitted after attenuation through a material.

Assuming normal incidence, the amount of reflected radiation, r, is calculated using the refractive index of the current material, n₁, and the refractive index of the material into which the radiation will enter, n₂:

$$r = {( \frac{{n}_{1} - {n}_{2}}{{n}_{1} + {n}_{2}} )}^{2} \qquad ( 1 )$$

Non-reflected radiation will continue to pass through to the next material. The amount of radiation transmitted through a material, t, is given by:

t=se^{-ab} (2)

where a is the material absorption coefficient, b is the thickness of the material, and s is the input radiation. The signal returned from the last layer encounters the most signal loss. For a structure with i layers, the end layer will encounter 4i-3 signal losses due to reflections at each layer interface and 2i-2 signal losses due to attenuation through each layer. Here it is assumed that material interfaces at each layer, even with consecutive material layers.

An infrastruct tag design aims to minimize t by selecting materials that have a low absorption coefficient in the THz region and minimal thickness. An appropriate r value should be based on the number of layers. With fewer layers, a higher difference in refractive index between materials is preferred to produce a stronger signal. However with more layers, a lower difference in refractive index allows a greater portion of the signal to reach the end layer of the code. In practice, air can be used as the low material to increase the difference in refractive index and maximize r.

1.6.3 Decoding Process

Once a tag has been modeled, fabricated, and scanned, the technique can use a procedure to convert the THz time domain data to the spatial-domain and decode the tag structure. The time domain data reveals the ‘optical distance’ between materials—the product of the distance the radiation has travelled and the refractive index of the medium it travelled through. Conversion from optical distance to real-world distance forms the basis of identifying material structures within an infrastruct tag. Optical distance, d, can be converted into real-world distance:

$$d = \frac{tnc}{2} \qquad ( 3 )$$

Here t is the time taken for the radiation to travel some distance, n is the refractive index of the medium, and c is the constant speed of light in a vacuum. As the time measurements are based on reflection, i.e., a two-way journey, the final value must be divided by two to calculate the real-world distance. To identify the sequence of materials inside an object two basic pieces of information are needed: material layer thickness, b, and refractive index, n. This allows the optical thickness of both materials to be pre-calculated.

Additionally, it is useful to know the location of the tag within the object and the number of tag layers, but these factors do not affect the basic functionality of the decoding algorithm. The previously described decoding procedure (Algorithm 1 shown below) takes advantage of the clear sequence of peaks in the returned time domain data. The first peak occurs as the signal travels from air into the outer enclosure, creating a negative peak. As the signal transitions out of the enclosure it generates a positive peak that acts as a starting point, p, to search for further peaks within the tag itself. The technique iteratively searches for negative peaks at a given offset from p, determined by the optical thickness of the high material. If the technique finds a peak over a given threshold it indicates there is a high material layer present. If there is no peak present a low material layer is assumed. This process is repeated until all layers are decoded into a sequence of bits representing the embedded signal. This basic algorithm is optimized for tag structures that have an interface between each material layer. Slight variations of the algorithm can support different structures.

Algorithm 1 Infrastruct Decoding

outerSurface = findNegativePeakAfter(0)
innerSurface = findPositivePeakAfter(outerSurface)
p = innerSurface // search start point
h = b₁n₁c // high material optical thickness
l = b₀n₀c // low material optical thickness
for each layer i do

peak = findNegativePeak(p + h, windowSize)
if peak then
p = peak
code[i] = 1 // high material

else

p = p + l
code[i] = 0 // low material

end if
end for

1.6.4 Designs

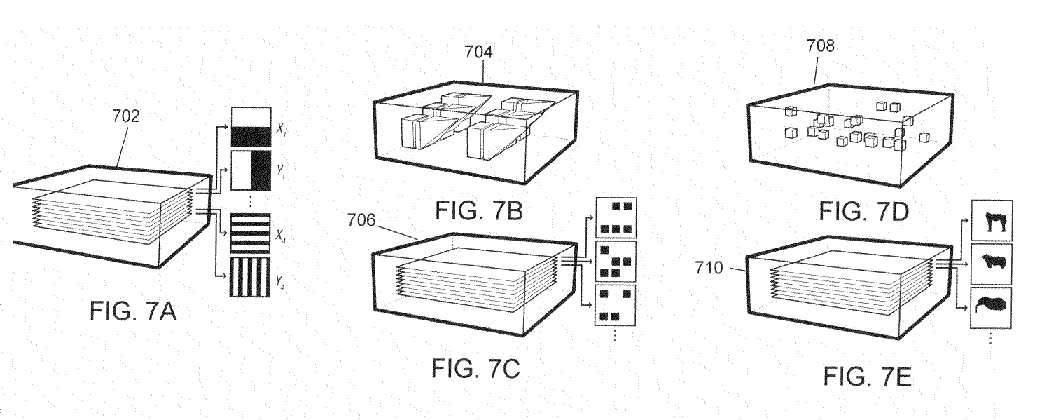

Infrastructs tags can encode information in numerous ways. Five prototype tag designs that demonstrate the different types of information and methods of encoding were developed as shown in FIGS. 7A, 7B, 7C, 7D and 7E.

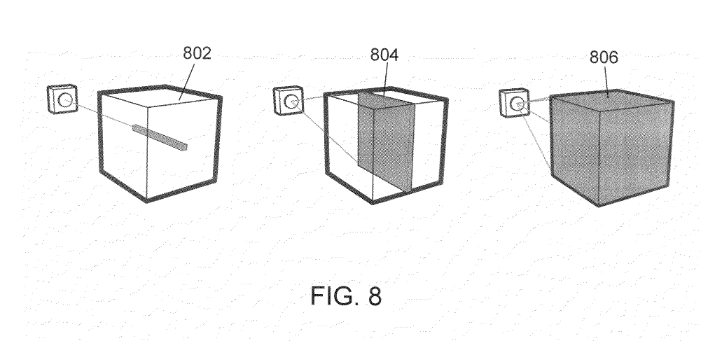

Each tag design is targeted towards a specific THz imaging configuration. The a) ray scan 802, b) planar scan 804, and c) volume scan 806 configurations represent the 1D, 2D, and 3D datasets respectively as shown in FIG. 8. The technique attempts to maximize the level of information that can be extracted with minimal data dimensions. As THz imaging devices advance, one expects to be able to utilize increasingly sophisticated THz scanning configurations. Each tag design has unique advantages/limitations and the right choice of tag will depend on the specific application.

1.6.4.1 Gray Code:

Sensing tag location is a key component of many ubiquitous computing applications. Understanding the precise location of physical objects enables interaction with nearby devices and digital content. Spatial Gray code patterns have been used to resolve location by displaying a sequence of binary patterns over time. Reading this sequence of binary values at any given location within the pattern results in a binary code that is unique to a spatial location. Based on this principle, an infrastruct tag design 702 was introduced for determining location using a multi-layered Gray code pattern (FIG. 7A). The technique encodes Gray codes patterns into material layers within an object. Using only a ray scan configuration, XY location can be decoded based on the sequence of material layers encountered. Additionally, the z depth value can be extracted based on TOF to the object surface.

1.6.4.2 Geometric:

Pose estimation can be achieved with a number of different sensing modalities. THz imaging enables an alternative form of pose estimation by looking inside objects to reveal structural information. Internal geometry within an object can be designed to reflect unique signals based on how they are positioned and oriented. One tag design 704 with embedded geometric structures (FIG. 7B) was designed to be read with a planar scan configuration. When scanned from above, a 2D image is generated that cuts through the object and reflects distinct signals from the geometric structures inside. The design of the internal geometry can be tailored to the specific degrees of freedom required.

1.6.4.3 Random Void:

The ability to uniquely identify a visibly homogenous object is important for a variety of application scenarios. Random physical structures have qualities that make them well suited to object identification. One tag design 706 employs a combined pose estimation/object identification technique using randomly placed THz-detectable features under the surface of an object (FIG. 7C). When scanned, the random features function as a unique fingerprint that can be matched to a stored 3D model containing the position of all features in the object. Due to the distributed nature of the random features, the main requirement is to capture a sufficient number of features so the identity and pose of the object can be uniquely determined. Either a planar or volume scan is used depending on feature density. One possible advantage of this technique is the creation of generic materials that can be cut into multiple pieces without affecting the matching process.

1.6.4.4 Matrix:

Storing data inside physical objects is useful for a range of applications and numerous schemes have been developed. In contrast to the Gray code tag design that uses a single ray scan, one embodiment of the technique uses a matrix tag 708 that embeds data in the volumetric space of an object (FIG. 7D). The matrix tag 708 contains layers of digital information encoded as physical bits and imaged using a volume scan configuration. To read all bits requires at least one TDS signal for each data point in the XY plane.

1.6.4.5 Visual:

THz volume scans can be used to encode visual information beneath the surface of objects. Although the surface material may be opaque, arbitrary shapes and patterns can be hidden inside an object. Human-readable ‘watermarks’ have applications in security to verify the authenticity of an object or in consumer products to provide the customer with proof that the object is not counterfeit. The embedded information can be easily recognized by a human provided they have the right equipment and know the information location. One embodiment of the technique uses a visual tag design 710 that embeds graphical shapes inside an object to form a 3D watermark (FIG. 7E). Each layer represents a parallel slice of a 3D object and is fabricated from multiple layers of material. A volume scan configuration is used to image the entire layer set.

### 1.7 Tag Fabrication

Some exemplary techniques used to fabricate and image infrastruct tags are discussed in the paragraphs below.

Infrastruct tags can range from thin film-like layers to volumetric structures that fill entire objects. To maximize the return signal materials with high transparency in the THz region are selected for use as the high material and air is used as the low material. This approach enables infrastruct tags to be fabricated using both additive and subtractive fabrication techniques—both have advantages and limitations depending on the type of tag.

1.7.1 Additive:

Additive manufacturing, or 3D printing, enables physical objects to be formed by selectively adding material layer by layer. Unlike conventional manufacturing methods, the additive process enables complex internal geometry to be fabricated. Interlinked, nested, and enclosed geometries can be fabricated, but require support material removal. Support material is a sacrificial material that provides structural support for overhanging or hollow areas of a model. Support material is typically removed after fabrication but can also become trapped inside of enclosed areas.

Because infrastruct tags utilize the internal space within objects, removing support material allows for hollow areas with highly reflective material transitions from material-air and air-material.

Using additive fabrication there are several ways to create hollow internal areas for use with infrastruct tags. One approach is to use self-supporting geometry where a small amount of step-over (overhang) from layer to layer allows hollow areas to be slowly closed. This approach is efficient because it does not require postprocessing, but it does place limits on the type of geometry that can be fabricated. Fused deposition modeling (FDM) 3D printers allow for a fairly substantial step-over and smaller step-overs are possible with material-jetting 3D printers. A second solution is to leave openings in the model that allow for support material to be removed; we use this approach when creating geometric tag designs. A third approach is to create a model in two pieces, remove support, then bond them together; this approach can be used when creating random void tag designs.

Multi-material 3D printers can also be used to design complex internal structures using a secondary material. Although materials with disparate softness and color can be fabricated side by side, many of the commercially available materials have similar refractive index values.

1.7.2 Subtractive:

Subtractive manufacturing encompasses a broad range of technologies that subtract (i.e., cut) from a raw material to form a desired shape. Laser cutters, vinyl cutters, and computer numerical control (CNC) mills in particular, although originally used in industrial settings, have become increasingly accessible due to the convenience of computer controlled fabrication.

Embodiments of the technique fabricate the Gray code, matrix, and visual tag designs from layers of polystyrene or high density polyethylene (HDPE) cut with a CO2 laser cutter by Universal Laser Systems. These materials are selected due to their refractive index and absorption coefficient properties—both materials are highly transparent in THz and also very inexpensive. The material layers are enclosed in 3D printed Acrylonitrile butadiene styrene (ABS) cases to ensure accurate alignment. Layer thicknesses down to 127 μm allow for thin film-like tags to be created. Material layers are packed tightly, but not physically bonded, allowing clear signal reflections to be achieved at each material interface.

### 2.0 Exemplary Operating Environment:

The infrastruct fabrication and imaging technique described herein is operational within numerous types of general purpose or special purpose computing system environments or configurations. FIG. 9 illustrates a simplified example of a general-purpose computer system on which various embodiments and elements of the infrastruct fabrication and imaging technique, as described herein, may be implemented. It should be noted that any boxes that are represented by broken or dashed lines in FIG. 9 represent alternate embodiments of the simplified computing device, and that any or all of these alternate embodiments, as described below, may be used in combination with other alternate embodiments that are described throughout this document.

For example, FIG. 9 shows a general system diagram showing a simplified computing device 900. Such computing devices can be typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, audio or video media players, etc.

To allow a device to implement the infrastruct fabrication and imaging technique, the device should have a sufficient computational capability and system memory to enable basic computational operations. In particular, as illustrated by FIG. 9, the computational capability is generally illustrated by one or more processing unit(s) 910, and may also include one or more GPUs 915, either or both in communication with system memory 920. Note that that the processing unit(s) 910 of the general computing device may be specialized microprocessors, such as a DSP, a VLIW, or other micro-controller, or can be conventional CPUs having one or more processing cores, including specialized GPU-based cores in a multi-core CPU. When used in special purpose devices such as the infrastruct fabrication and imaging technique, the computing device can be implemented as an ASIC or FPGA, for example.

In addition, the simplified computing device of FIG. 9 may also include other components, such as, for example, a communications interface 930. The simplified computing device of FIG. 9 may also include one or more conventional computer input devices 940 (e.g., pointing devices, keyboards, audio and speech input devices, video input devices, haptic input devices, devices for receiving wired or wireless data transmissions, etc.). The simplified computing device of FIG. 9 may also include other optional components, such as, for example, one or more conventional computer output devices 950 (e.g., display device(s) 955, audio output devices, video output devices, devices for transmitting wired or wireless data transmissions, etc.). Note that typical communications interfaces 930, input devices 940, output devices 950, and storage devices 960 for general-purpose computers are well known to those skilled in the art, and will not be described in detail herein.

The simplified computing device of FIG. 9 may also include a variety of computer readable media. Computer readable media can be any available media that can be accessed by computer 900 via storage devices 960 and includes both volatile and nonvolatile media that is either removable 970 and/or non-removable 980, for storage of information such as computer-readable or computer-executable instructions, data structures, program modules, or other data. Computer readable media may comprise computer storage media and communication media. Computer storage media refers to tangible computer or machine readable media or storage devices such as DVD's, CD's, floppy disks, tape drives, hard drives, optical drives, solid state memory devices, RAM, ROM, EEPROM, flash memory or other memory technology, magnetic cassettes, magnetic tapes, magnetic disk storage, or other magnetic storage devices, or any other device which can be used to store the desired information and which can be accessed by one or more computing devices.

Storage of information such as computer-readable or computer-executable instructions, data structures, program modules, etc., can also be accomplished by using any of a variety of the aforementioned communication media to encode one or more modulated data signals or carrier waves, or other transport mechanisms or communications protocols, and includes any wired or wireless information delivery mechanism. Note that the terms “modulated data signal” or “carrier wave” generally refer to a signal that has one or more of its characteristics set or changed in such a manner as to encode information in the signal. For example, communication media includes wired media such as a wired network or direct-wired connection carrying one or more modulated data signals, and wireless media such as acoustic, RF, infrared, laser, and other wireless media for transmitting and/or receiving one or more modulated data signals or carrier waves. Combinations of any of the above should also be included within the scope of communication media.

Further, software, programs, and/or computer program products embodying some or all of the various embodiments of the infrastruct fabrication and imaging technique described herein, or portions thereof, may be stored, received, transmitted, or read from any desired combination of computer or machine readable media or storage devices and communication media in the form of computer executable instructions or other data structures.

Finally, the infrastruct fabrication and imaging technique described herein may be further described in the general context of computer-executable instructions, such as program modules, being executed by a computing device. Generally, program modules include routines, programs, objects, components, data structures, etc., that perform particular tasks or implement particular abstract data types. The embodiments described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

It should also be noted that any or all of the aforementioned alternate embodiments described herein may be used in any combination desired to form additional hybrid embodiments. Although the subject matter has been described in language specific to structural features and/or methodological acts, it is to be understood that the subject matter defined in the appended claims is not necessarily limited to the specific features or acts described above. The specific features and acts described above are disclosed as example forms of implementing the claims.

What is claimed is:

1. A computer-implemented process for embedding information in a volumetric tag inside of an object, comprising:
encoding information in a volumetric tag inside a three dimensional physical object during manufacture of the object; and
reading the encoded information using a terahertz (THz) imaging reader.

2. The computer-implemented process of claim 1 wherein the encoded information is read by emitting a pulse of THz radiation, toward the object and measuring the reflected pulse from material interfaces encountered at outer and inner surfaces of the object.

3. The computer-implemented process of claim 2 wherein the emitted pulse is a broadband pulse and the entire measured reflected pulse is measured as a waveform.

4. The computer-implemented process of claim 1 wherein the terahertz (THz) imaging reader uses Time Domain Spectroscopy (TDS) images of the surface and the interior of the physical object to read the encoded information.

5. The computer-implemented process of claim 4 wherein each pixel of a TDSimage comprises a time-domain signal with peaks that indicate reflected energy from both the outer surfaces and the inner surfaces of the physical object.

6. The computer-implemented process of claim 5 wherein the entire TDS image forms a volumetric data set that can be used to slice through the object along the depth axis of the object and reveal the three dimensional structure.

7. The computer-implemented process of claim 1 wherein the physical object is digitally fabricated.

8. The computer-implemented process of claim 1 wherein information is encoded at material transitions of layers of the physical object in order to create the volumetric machine-machine readable tag.

9. The computer-implemented process of claim 1 wherein the volumetric tag is used for data storage.

10. The computer-implemented process of claim 1 wherein the volumetric tag is used for authentication.

11. The computer-implemented process of claim 1 wherein the material used to create the tag is selected based on reflected radiation of the material and the amount of radiation transmitted through the material after attenuation.

12. A computer-implemented process for creating a volumetric machine-readable tag that is embedded in a three dimensional physical object, comprising:
encoding information at material transitions of layers of the physical object during manufacture of the object in order to create the volumetric machine-readable tag during fabrication of the object.

13. The computer-implemented process of claim 12 wherein layers of materials of different refractive properties are used to create the volumetric machine-readable tag.

14. The computer-implemented process of claim 12 wherein a multi-layered spatial gray code pattern is used to encode the information in the volumetric machine-readable tag.

15. The computer-implemented process of claim 14 wherein a ray scan configuration is used to read the information on the volumetric machine-readable tag.

16. The computer-implemented process of claim 12, further comprising embedding the volumetric tag in the object in a manner so as to provide information on how the object is positioned and oriented.

17. The computer-implemented process of claim 12 further comprising randomly placing tag information under the surface of the object as a unique footprint of the object that can be scanned and matched to a 3D model containing the position of all of the features of the object.

18. The computer-implemented process of claim 12 wherein the volumetric tag is a matrix tag that contains layers of digital information encoded as physical bits and is imaged using a volume scan configuration.

19. The computer-implemented process of claim 12 wherein the volumetric tag has a three dimensional shape recognizable by a human when scanned.

20. A system for encoding a machine-readable tag inside of a three dimensional physical object during manufacture of the object, comprising:
creating a digital model of a three dimensional object;
encoding information inside a volumetric tag inside a three dimensional physical object during manufacture of the object using the digital model.
